(19) United States
(12) Patent Application Publication
(10) Pub. No.: US 2018/0004210 A1
(43) Pub. Date: Jan. 4, 2018

(54) Affecting Functions of a Vehicle Based on Function-Related Information about its Environment

(71) Applicant: nuTonomy Inc., Cambridge, MA (US)

(72) Inventors: Karl Iagnemma, Cambridge, MA (US); Eric Wolff, Cambridge, MA (US); Baoxing Qin, Singapore (SG)

(21) Appl. No.: 15/200,050

(22) Filed: Jul. 1, 2016

(51) Int. Cl. G05D 1/02; G05D 1/00; H04L 29/08

(52) U.S. Cl. CPC G05D 1/0212; H04L 67/18; G05D 1/0088; H04L 67/12

(57) ABSTRACT

Among other things, information is received about a function-related feature of an environment of a vehicle that has been identified in connection with a location of the vehicle. Execution of a function of the vehicle is affected to alter performance characteristics of the function based on the identified function-related feature.

This description relates to affecting functions of a vehicle based on function-related characteristics of its environment.

An autonomous vehicle can drive safely without human intervention during part of a journey or an entire journey.

An autonomous vehicle includes sensors, actuators, computers, and communication devices to enable automated generation and following of routes through the environment. Some autonomous vehicles have wireless two-way communication capability to communicate with remotely-located command centers that may be manned by human monitors, to access data and information stored in a cloud service and to communicate with emergency services.

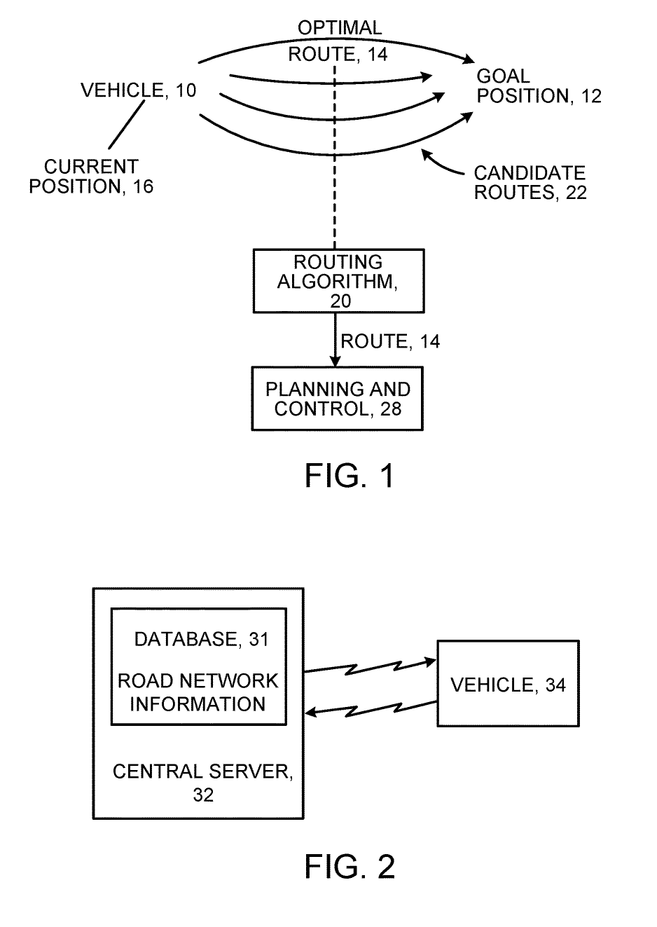

As shown in FIG. 1, in a typical use of an autonomous vehicle 10, a desired goal position 12 (e.g., a destination address or street intersection) may be identified in a variety of ways. The goal position may be specified by a rider (who may be, for example, an owner of the vehicle or a passenger in a mobility-as-a-service “robo-taxi” application). The goal position may be provided by an algorithm (which, for example, may be running on a centralized server in the cloud and tasked with optimizing the locations of a fleet of autonomous vehicles with a goal of minimizing rider wait times when hailing a robo-taxi). In some cases, the goal position may be provided by a process (e.g., an emergency process that identifies the nearest hospital as the goal position due to a detected medical emergency on board the vehicle).

Given a desired goal position, a routing algorithm 20 determines a route 14 through the environment from the vehicle's current position 16 to the goal position 12. We sometimes call this process “route planning.” In some implementations, a route is a series of connected segments of roads, streets, and highways (which we sometimes refer to as road segments or simply segments).

Routing algorithms typically operate by analyzing road network information. Road network information typically is a digital representation of the structure, type, connectivity, and other relevant information about the road network. A road network is typically represented as a series of connected road segments. The road network information, in addition to identifying connectivity between road segments, may contain additional information about the physical and conceptual properties of each road segment, including but not limited to the geographic location, road name or number, road length and width, speed limit, direction of travel, lane edge boundary type, and any special information about a road segment such as whether it is a bus lane, whether it is a right-turn only or left-turn only lane, whether it is part of a highway, minor road, or dirt road, whether the road segment allows parking or standing, and other properties.

The routing algorithm typically identifies one or more candidate routes 22 from the current position to the goal position. Identification of the best, or optimal, route 14 from among the candidate routes is generally accomplished by employing algorithms (such as A*, D*, Dijkstra's algorithm, and others) that identify a route that minimizes a specified cost. This cost is typically a function of one or more criteria, often including the distance traveled along a candidate route, the expected time to travel along the candidate route when considering speed limits, traffic conditions, and other factors. The routing algorithm may identify one or more than one good routes to be presented to the rider (or other person, for example, an operator at a remote location) for selection or approval. In some cases, the one optimal route may simply be provided to a vehicle trajectory planning and control module 28, which has the function of guiding the vehicle toward the goal (we sometimes refer to the goal position simply as the goal) along the optimal route.

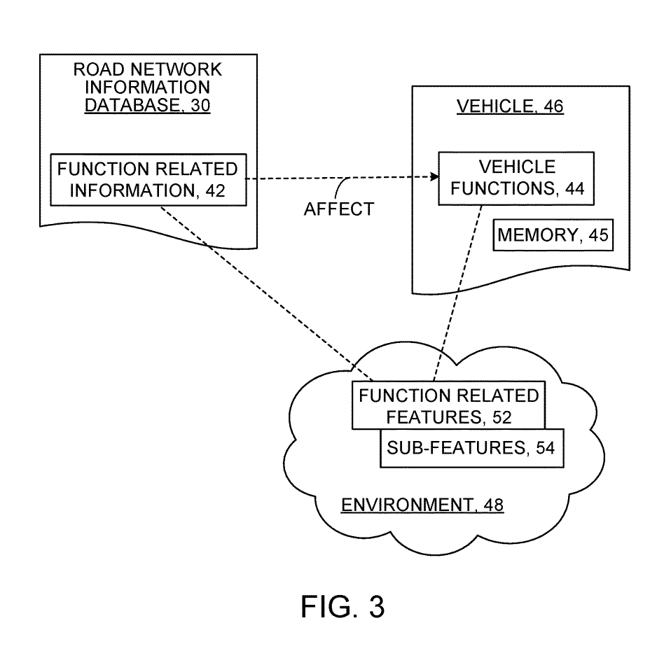

As shown in FIG. 2, road network information 31 typically is stored in a database 30 that is maintained on a centrally accessible server 32 and may be updated at high frequency (e.g., 1 Hz or more). The network information can be accessed either on-demand (e.g., requested by the vehicle 34), or pushed to the vehicle by the server.

Road network information can have temporal information associated with it, to enable descriptions of traffic rules, parking rules, or other effects that are time dependent (e.g., a road segment that does not allow parking during standard business hours, or on weekends, for example), or to include information about expected travel time along a road segment at specific times of day (e.g., during rush hour).

### SUMMARY

In general, in an aspect, information is received about a function-related feature of an environment of a vehicle that has been identified in connection with a location of the vehicle. Execution of a function of the vehicle is affected to alter performance characteristics of the function based on the identified function-related feature.

Implementations may include one or a combination of two or more of the following features. The function-related feature includes a geographic region. The function-related feature includes a road feature. The function includes a software process. The function includes motion planning. The function includes trajectory tracking. The function includes actuator control. The function includes decision-making. The function includes perception processing. The function includes localization of the vehicle. The function includes sensor data recording on-board the vehicle. The execution of the function is affected by switching from one function to another function. The execution of the function is affected by altering an operation of a function. The affecting of the execution of the function is based on parameter settings. The parameter settings are selected from among two or more different sets of parameter settings. The affecting of the execution of the function is based on prior information. The prior information includes a simulation model. The prior information includes two or more simulation models. The information about the function-related feature is received from a database.

In general, in an aspect, information is received that identifies or defines a function-related feature of an environment of a vehicle. Function-related information is generated that corresponds to the function-related feature.

Implementations may include one or a combination of two or more of the following features. The information is received from an automated process. The information is received from a user interacting with a user interface. The information is received from a combination of an automated process and a user interacting with a user interface. The function-related information includes a location that corresponds to the function-related feature. The function-related feature includes a geographic region that corresponds to the function-related feature. The function-related feature includes a road feature. The information is received while the vehicle is traveling in the vicinity of the function-related feature. The generated function-related information is stored in a database. The database includes a road network information database that includes information about road segments. The function-related information is fed through a communication network to a location where a road network information is accumulated.

These and other aspects, features, implementations, and advantages, and combinations of them, can be expressed as methods, systems, components, apparatus, program products, methods of doing business, means and steps for performing functions, and in other ways.

Other aspects, features, implementations, and advantages will become apparent from the following description and from the claims.

### DESCRIPTION

FIGS. 1 through 4A-4B and 5 are block diagrams.

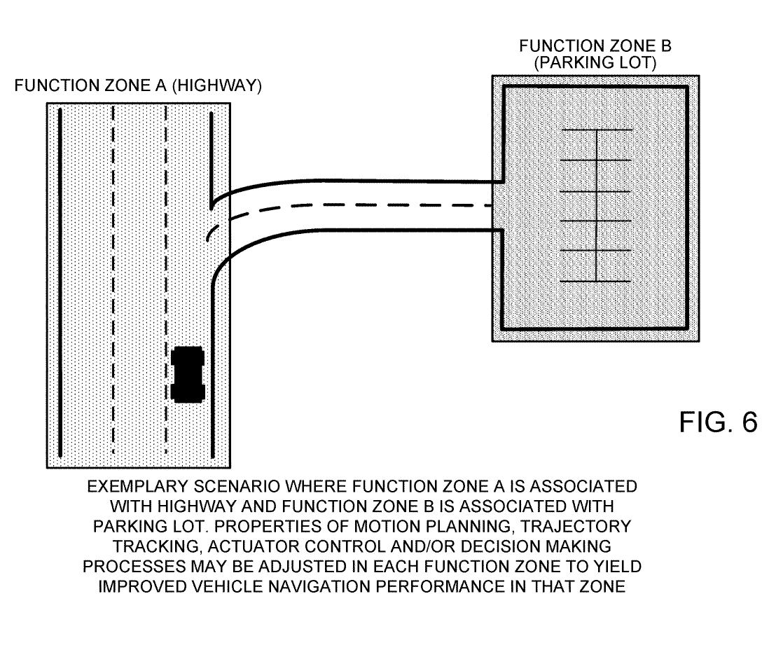

FIGS. 6 through 9 show scenarios.

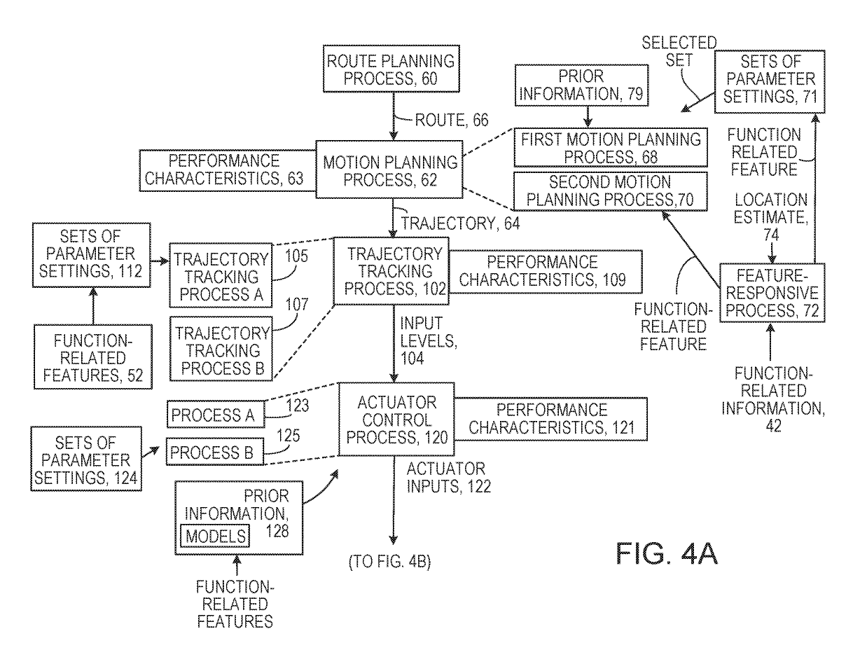

As shown in FIG. 3, in some implementations of the techniques and systems that we describe here, a road network information database 30 stores not only information about the nature of the road segments of the road network, but also information 42 about features of the environment 48 that relate to functions 44 of a vehicle 46 (for example, an autonomous vehicle). In some cases, the functions of the vehicle are functions performed by software processes.

We sometimes refer to this information broadly as “function-related information” and to the functions of the vehicle broadly as “vehicle functions.” Such function-related information may be used not only to select a route but also to manage, control, influence, inform, or otherwise (in broad terms) “affect” the functions and performance of a vehicle. In some implementations, the function-related information is used to affect the vehicle functions by modifying the type, structure, or performance (or a combination of them) of software processes on the vehicle.

We here introduce the term “function-related features” 52 which we use broadly to include, for example, any location or geographic region or other features of the environment of a vehicle that can be related to one or more vehicle functions. The identity or location or boundary or other identification information for a function-related feature 52 is part of the function-related information that is stored in a road network information database or similar database.

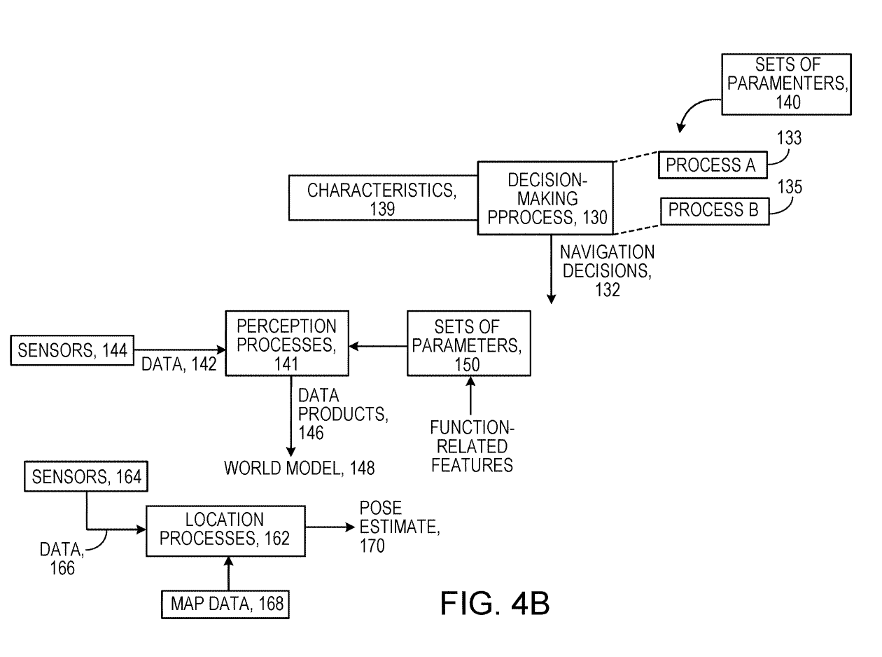

Referring to FIGS. 4A and 4B, as an example, consider a self-driving vehicle (we sometimes use the terms “autonomous” and “self-driving” synonymously) that uses a particular software process 62 for motion planning. Vehicles capable of highly automated driving (e.g., autonomous vehicles) rely on a motion planning process, e.g., an algorithmic process, to automatically generate and execute a trajectory 64 through the environment toward a designated short-term goal. We use the term “trajectory” broadly to include, for example, any path from one place to another. To distinguish the trajectory 64 that is generated by the motion planning process from the route 66 that is generated by a route planning process, we note that trajectories are paths through the vehicle's immediate surroundings (e.g., with distance scales typically on the order of several meters to several hundred meters). A trajectory is specifically designed to be free of collisions with obstacles and often to have desirable characteristics related to path length, ride quality, required travel time, lack of violation of rules of the road, adherence to driving practices, or other factors and combinations of them. We sometimes use the terms “trajectory” and “path” interchangeably and sometimes refer to either of them as the “output” or “result” of the motion planning process. We note that various motion planning processes may exhibit different properties, including the frequency at which they can generate trajectories, the types of trajectories that they generate (including the density and complexity of the trajectories), and other factors.

As illustrated also in FIG. 6, consider an autonomous vehicle that uses a first motion planning software process 68 to enable navigation in crowded parking lots, and a second motion planning software process 70 to enable navigation on fast-moving freeways. The function-related information in the database can include a defined function-related feature associated with a geographic region of a parking lot and another defined function-related feature associated with a geographic region of a freeway. Then a self-driving car's ability to maintain an accurate estimate 74 of its own geographic location can be exploited by a feature-responsive software process 72 to continually identify any function-related information in the database that identifies a feature that matches a vehicle's current location. Once identified, the process 72 can select an appropriate motion planning software process, e.g., process 68 or process 70, or can otherwise modify a structure or performance of motion planning software processes on the vehicle automatically to cause the vehicle to proceed in a way that is appropriate for, in this example, either the parking lot function-related feature or the freeway function-related feature.

Function-related features may include a wide variety of different types of features of the environment of the vehicle.

For example, function-related features may be associated with physical roadway structures such as pedestrian crosswalks, intersection zones, railway crossing areas; freeways, turnpikes, highways, and other high-speed travel zones; secondary roads; parking lots; pedestrian zones that allow vehicular traffic; designated school zones; driveways, road shoulders or breakdown lanes; toll booths; gas stations or electric vehicle charging stations; taxi stands; car rental lots; airport arrival/departure levels; construction zones; areas with known vehicle-to-vehicle (v2v) or vehicle-to-infrastructure (v2i) capability; designated autonomous vehicle travel areas (e.g., specified travel lanes or road regions that only admit passage to autonomous vehicles); drive-throughs (e.g., for bank automated tellers, or fast food), or car washes, to name a few.

Function-related features may be associated with drivable areas such as portions of a road, parking lot, unpaved drivable area, or other drivable surface.

In addition to identifying or defining different types of function-related features to be represented by function-related information in the database, sub-features 54 (FIG. 3) of function-related features can also be identified or defined. For example, if secondary roads are a type of function-related feature, different lane markings (e.g., painted lane lines and Botts dots) of secondary roads can be identified as such sub-features in the database.

Function-related sub-features can be identified or defined based on geographic proximity to objects or road features of interest. For example, a section of a secondary road that is near to a stop or yield sign can be identified in the database as a sub-feature having proximity to objects or road features of interest.

Different portions of function-related features that lie in different geographic places, and therefore are associated with different driving rules or customs, can be identified in the database as being in the corresponding geographic places. For example, an instance of a type “geographic region” can be defined as a 2D polygon describing the geographic extent of the function-related feature, such as an ordered set of 2D coordinates, together with a unique map identifier for which the 2D coordinates are valid. An instance of a type “road feature” (such as a specific traffic sign or a set of traffic signs) could be defined by a set of 2D coordinates together with a unique map identifier for which 2D coordinates are valid.

The following are exemplary ways in which vehicle functions (e.g., software processes) of self-driving vehicles can be invoked or modified (that is, affected) based on function-related feature information.

### Motion Planning Processes

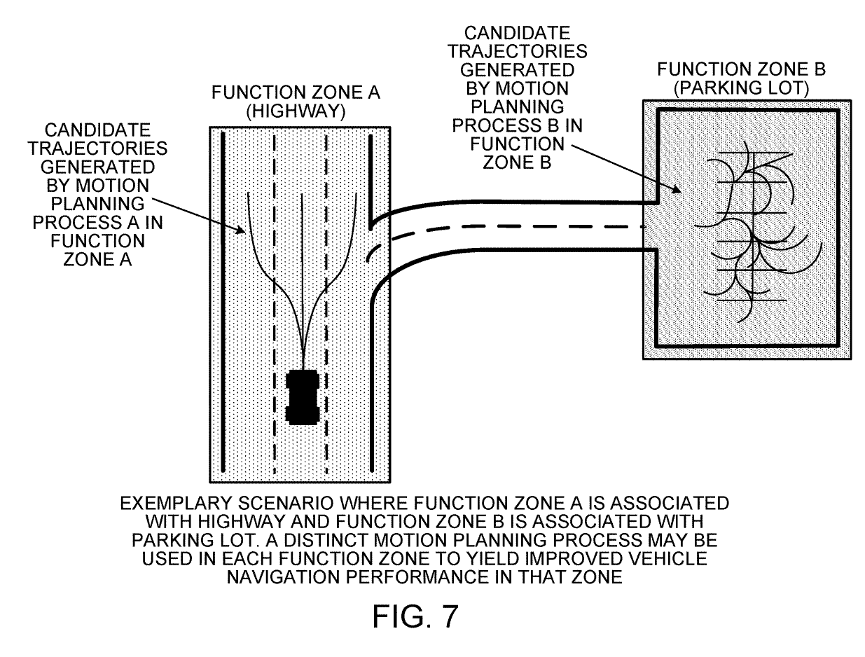

As mentioned earlier and as also illustrated in FIG. 7, self-driving vehicles use software processes termed motion planning processes to generate candidate trajectories (e.g., time-parameterized paths) that the ego vehicle may follow through the environment during a configurable time horizon T. The generated candidate trajectories are stored in a memory unit 45 (FIG. 3) on the vehicle. Generation of such candidate trajectories can be accomplished by a variety of known techniques, including techniques relying on state lattices, graph search techniques, constrained or unconstrained optimization, or techniques utilizing randomized planning methods such as probabilistic road maps or rapidly-exploring random trees. Such motion planning methods typically consider the locations of obstacles relative to the vehicle when generating candidate trajectories, so that candidate trajectories that would result in collision with one or more obstacles are removed from consideration. The result of the computations done at each time step k in a motion planning process includes a desirable, or sometimes optimal, trajectory 64 from the position of the ego vehicle at time k to the position of the vehicle at time k+T.

Certain motion planning processes may exhibit performance characteristics 63 (FIG. 4A) that vary depending on the operational environment, e.g., depending on function-related features of the environment. Therefore, as suggested earlier, it may be desirable to be able to associate particular motion planning processes (such as processes 68 and 70 shown in FIG. 4A) with particular types of function-related features, so that when the ego vehicle enters or leaves or transitions between function-related features it changes its motion planning processes accordingly.

For example, a certain motion planning process (process A) may be able quickly to generate candidate trajectories that exhibit little path curvature and may therefore be well-suited to motion planning for driving at high speeds on highways, where due to high vehicle travel speeds it is impossible to safely follow high-curvature trajectories. Another motion planning process (process B) may require greater computational effort and therefore operate at a lower update rate than process A, but may be able to generate complex (e.g., involving high path curvature or multi-point turn) trajectories, and may therefore be well-suited to motion planning for driving at low-speeds in parking lots and driveways.

In other words, managing the most effective operation of a motion planning process may depend on responding to characteristics of function-related features that are to be traveled.

Therefore, based on known properties (performance characteristics) of motion planning process A and motion planning process B, it may be desirable to use process A for function-related features that are associated with highways, freeways, turnpikes, and other high-speed travel zones, and process B for function-related features associated with parking lots, driveways, pedestrian zones that allow vehicular traffic, and other low-speed travel zones that require complex maneuvering.

### Parameter Settings for a Given Motion Planning Process

Motion planning processes of various types generally rely on user-selected parameter settings 71 (FIG. 4A) that influence the performance characteristics and output of the motion planning process.

As a result, the output of a given motion planning process that uses given parameter settings may be better suited (and therefore result in improved performance, by some metric) to the properties of a particular function-related feature. Therefore, it may be desirable to associate different sets of parameters for a given motion planning process with corresponding different function-related features.

For example, a certain motion planning process based on a class of algorithms known as rapidly exploring random trees (RRT), employing a parameter set A, tends to bias the RRT algorithm tree growth along a pre-defined nominal route. Such an approach may exhibit better performance characteristics (e.g., faster identification of a path of motion whose quality exceeds some user-defined threshold) in driving scenarios that do not require complex maneuvering, compared to the same motion planning process employing parameter set B, which does not tend to bias the RRT algorithm tree growth toward any particular route.

In some cases, a certain motion planning process based on a class of algorithms known as state lattices, using a parameter set A, defines a coarsely-spaced lattice in both space and time and therefore enables only coarse vehicle maneuvers and can identify candidate motion trajectories extremely rapidly. Such an approach may exhibit better performance characteristics (e.g., faster identification of a motion path whose quality exceeds some user-defined threshold) in a range of high-speed driving scenarios compared to the same planning process using a parameter set B, which defines a finely-spaced lattice in both space and time and therefore enables precise maneuvering at the cost of additional computation time.

Therefore, based on known properties of a motion planning process that can employ parameter set A or parameter set B, it may be desirable to arrange for the use of parameter set A for function-related features that are associated with highways, freeways, turnpikes, and other high-speed travel zones and the parameter set B for function-related features associated with parking lots, driveways, pedestrian zones that allow vehicular traffic, and other low-speed travel zones that require complex maneuvering. In some implementations, the two different parameter sets may be employed by a single given motion planning process. In some cases, the two different parameter sets may be employed by two different motion planning processes or two separate instances of a single process.

Motion planning process parameter settings can also be adjusted to influence common vehicle operational settings such as the travel speed, nominal and maximum longitudinal and lateral acceleration and deceleration, and other settings.

### Use of Motion Planning Process Prior Information

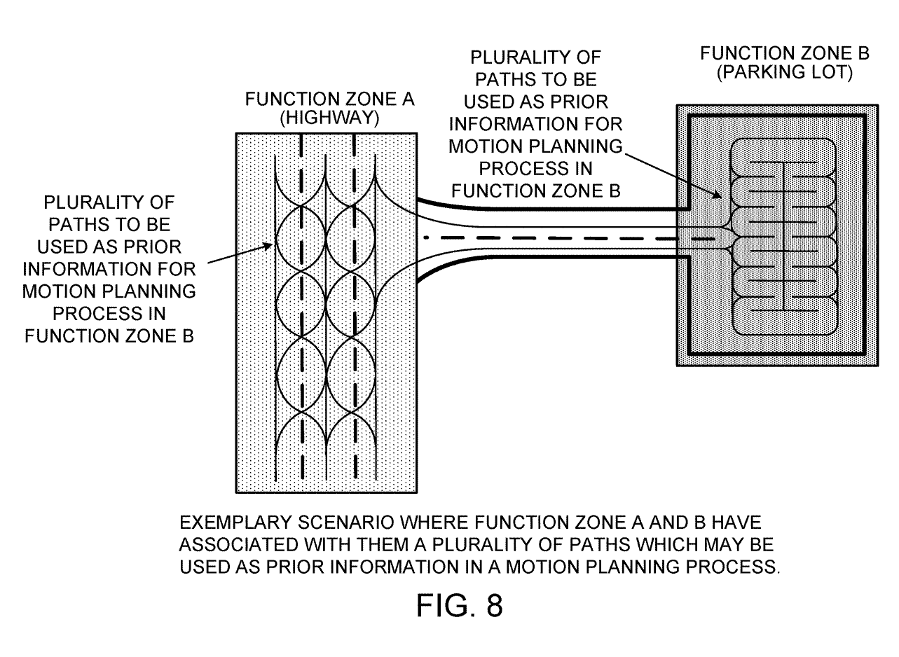

Motion planning processes of various types may take advantage of information of various types (“prior information”) that is provided or available at initiation of the motion planning process or at a time prior to the planning of motion. Such prior information 79 (FIG. 4A and as also illustrated in FIG. 8) may be used to influence the performance characteristics or output or both of the motion planning processes. Using prior information may produce output from a given motion planning process that is better suited (and therefore results in improved performance, by some metric) to the properties of a particular type of function-related feature, compared to when the motion planning process does not make use of prior information. Therefore, it may be desirable to associate prior information with you different types of function-related features.

For example, given information about an ego vehicle's current position and goal position, and knowledge of properties of the road network e.g., function-related information 42, it may be possible to compute a nominal path from the current position to the goal position under the assumption that the route is free of obstacles. This nominal path can then be provided to the motion planning process as prior information, which may reduce the burden on the planning process of computing a path in certain scenarios. The nominal path can also take account of other information associated with the applicable function-related feature, such as the nominal travel speed, which influences the path curvature that can be followed by the vehicle to within a specified precision.

In some cases, given knowledge of the properties of the road network stored in the database, it may be possible to compute multiple nominal paths between a collection of start positions and goal positions on the road network. This collection of nominal paths can then be provided to the motion planning process as prior information, which may reduce the burden on the planning process of computing a motion plan in certain scenarios. This type of prior information may be especially useful in scenarios that require complex maneuvering, such as parking lots, because complex maneuvers can be challenging or time consuming to compute using a motion planning process, and the presentation of the nominal paths as prior information can reduce the computational burden.

### Trajectory Tracking Processes

As also shown in FIGS. 4A and 4B, self-driving vehicles typically use software processes termed trajectory tracking (or path tracking) processes 102 to compute a set of input levels (e.g., effort levels of the steering, brake, and throttle) 104 to cause the vehicle to follow (we sometimes say to track) a trajectory or path 68 provided by a motion planning process 62 to within a specified precision. Such input levels can be generated by a variety of known techniques, including model predictive control (MPC), pure pursuit, fuzzy logic, neural networks (including convolutional neural networks and similar “deep learning” methods), and other techniques. The result of the computations done at each time step k in a trajectory tracking process includes a set of input levels that is intended to be applied at the current time step, and may also include a set of inputs that are intended to be applied from the current time to a future time k+T.

Certain trajectory tracking processes may exhibit performance characteristics that vary depending on the operational environment, for example, a function-related feature associated with the vehicle's location. Therefore, it may be desirable to associate different trajectory tracking processes with corresponding different function-related features, so that when the ego vehicle enters or leaves or transitions between function-related features it also transitions between execution of different trajectory tracking processes.

For example, a certain trajectory tracking process (process A) 105 based on a pure pursuit algorithm may quickly generate sets of input levels that are suitable for tracking paths that exhibit little path curvature, and may therefore be well-suited to driving at high speeds on highways for which it is impossible to safely follow high-curvature trajectories. In contrast, another trajectory tracking process (process B) 107 based on MPC may require greater computational effort and therefore operate at a lower update rate than process A, but may generate sets of input levels that are suitable for tracking complex (e.g., involving high path curvature or multi-point turn) trajectories, and may therefore be well-suited to driving at low-speeds in parking lots and driveways.

Therefore, based on known properties (e.g., performance characteristics 109) of trajectory tracking process A and trajectory tracking process B, it may be desirable to use process A to track paths in function-related features that are associated with highways, freeways, turnpikes, and other high-speed travel zones, and process B to track paths in function-related features associated with parking lots, driveways, pedestrian zones that allow vehicular traffic, and other low-speed travel zones that require complex maneuvering.

### Adjustment of Trajectory Tracking Process Parameter Settings

Trajectory tracking processes of various types generally rely on user-selected parameter settings 112 that influence the performance characteristics and input levels that are the output of a trajectory tracking process. As a result, the output from a given trajectory tracking process that uses given parameter settings may be better suited (and therefore yield better performance, by some metric) to the properties of a particular type of function-related feature. Therefore, it may be desirable to associate different sets of parameters for a single trajectory tracking process with different types of function-related features.

For example, a certain trajectory tracking process that is based on a pure pursuit algorithm and uses a parameter set A, which includes a large “look ahead distance,” may track trajectories more accurately in driving scenarios that do not require high curvature maneuvering, compared to the same trajectory tracking process using parameter set B, which includes a small look ahead distance, and results in accurate tracking of high curvature trajectories.

In some cases, a certain trajectory tracking process based on a class of algorithms known as MPC, and using a parameter set A, may define a cost function that weakly penalizes deviation from the trajectory provided by the motion planning process. This approach may produce coarse maneuvering, though also may generate steering inputs that have relatively small rate of change of amplitude and are comfortable to a passenger. By contrast, the same trajectory tracking process using parameter set B, which defines a cost function that heavily penalizes deviation from the trajectory provided by the motion planning process and therefore results in precise maneuvering, may yield steering inputs that have relatively large rate of change of amplitude and are less comfortable to a passenger.

Therefore, based on known properties of the trajectory tracking process when using different parameter sets (such as parameter set A or parameter set B), it may be desirable to have the process use a parameter set A for paths for function-related features that are associated with highways, freeways, turnpikes, and other high-speed travel zones, and to use a parameter set B for paths for function-related features associated with parking lots, driveways, pedestrian zones that allow vehicular traffic, and other low-speed travel zones that require complex maneuvering.

### Actuator Control Processes

As also shown in FIGS. 4A and 4B, self-driving vehicles use software processes 120 termed actuator control processes to compute sets of actuator inputs 122 (e.g., electronic commands to actuators that modulate the effort exerted by the steering, brake, and throttle) to cause each actuator to attain the input level provided by the trajectory tracking process. Such actuator input sets can be generated by a variety of known techniques, including MPC, the family of proportional-integral-derivative control techniques, neural networks (including convolutional neural networks and similar “deep learning” methods), and other techniques and combinations of them. The result of the computations done at each time step k in an actuator control process includes a set of actuator inputs that is intended to be applied at the current time step, and may also include a set of actuator inputs that are intended to be applied from the current time to a future time k+T.

Certain actuator control processes may exhibit performance characteristics 121 that vary depending on the vehicle operational conditions and the environment conditions. Therefore, it may be desirable to associate different actuator control processes with corresponding different function-related features. Then ego vehicle transitions between function-related features can cause transitions between executions of different corresponding actuator control processes. Changes in vehicle operational conditions may include, for example, changes in vehicle speed, changes in engine throttle level, changes in selected transmission gear, and others. Changes in the environment conditions may include, for example, road surface friction levels, road pitch and roll, road roughness levels, whether or not it is raining or snowing or has recently rained or snowed, whether or not there is slush or puddles present on the road, and others.

For example, a certain throttle actuator control process (process A) 123 may yield accurate tracking of a desired throttle input level when the engine RPM level is relatively high and may therefore be well-suited to scenarios involving driving at high speeds on highways. Another throttle actuator control process (process B) 125 may yield accurate tracking of desired throttle input levels when the engine RPM level is relatively low and may therefore be well-suited to scenarios involving tracking complex (e.g., involving high path curvature or multi-point turn) trajectories, such as driving at low-speeds in parking lots and driveways. ←Best is to state the general principle (throttle actuator processes have different properties that correspond to different scenarios) then give two or three different examples to provide a robust base to assert that you have full grasp of the broad concept as of the time of filing of the patent application.]

In some cases, a certain steering actuator control process (process A) may yield accurate tracking of a desired steering input level when the vehicle speed level is relatively high and the wheel “scrubbing” torque that resists turning is thus relatively low and may therefore be well-suited to scenarios involving driving at high speeds on highways. Another steering actuator control process (process B) may yield accurate tracking of desired steering input levels when the vehicle speed is relatively low and the wheel “scrubbing” torque that resists turning is thus relatively high, and may therefore be well-suited to scenarios involving tracking complex (e. G., involving high path curvature or multi-point turn) trajectories, such as driving at low-speeds in parking lots and driveways.

Therefore, in both examples and other examples, based on known properties of actuator control process A and actuator control process B, it may be desirable to use process A for function-related features that are associated with highways, freeways, turnpikes, and other high-speed travel zones and process B for function-related features associated with parking lots, driveways, pedestrian zones that allow vehicular traffic, and other low-speed travel zones that require complex maneuvering.

### Actuator Control Process Parameter Settings

As also shown in FIGS. 4A and 4B, actuator control processes of various types generally rely on user-selected parameter settings 124 that influence the performance characteristics and output of the actuator control process. As a result, the output from a given actuator control process that uses given parameter settings may be better suited (and therefore yield better performance, by some metric) to the properties of a particular type of function-related feature. Therefore, it may be desirable to associate different sets of parameters for a given actuator control process with different corresponding types of function-related features.

For example, a certain throttle actuator control process based on a proportional-derivative algorithm, using a parameter set A, may track a desired throttle input level more accurately when the engine RPM level is relatively high and may therefore be well-suited to scenarios involving driving at high speeds on highways. The same throttle actuator control process based on the proportional-derivative algorithm, and using a parameter set B, may track the throttle input levels more accurately when the engine RPM level is relatively low and may therefore be well-suited to scenarios involving tracking complex (e.g., involving high path curvature or multi-point turn) trajectories, such as driving at low-speeds in parking lots and driveways.

In some cases, a certain steering actuator control process, using a parameter set A having relatively low proportional gain, may track a steering input level more accurately when the vehicle speed level is relatively high and the wheel “scrubbing” torque that resists turning is thus relatively low and may therefore be well-suited to scenarios involving driving at high speeds on highways. The same steering actuator control process using a parameter set B with relatively high proportional gain may track steering input levels more accurately when the vehicle speed is relatively low and the wheel “scrubbing” torque that resists turning is thus relatively high and may therefore be well-suited to scenarios involving tracking complex (i.e. involving high path curvature, multi-point turns) trajectories, such as driving at low-speeds in parking lots and driveways.

Therefore, based on known properties of the actuator control process employing parameter set A and employing parameter set B, it may be desirable to apply parameter set A to function-related features that are associated with highways, freeways, turnpikes, and other high-speed travel zones, and parameter set B to function-related features associated with parking lots, driveways, pedestrian zones that allow vehicular traffic, and other low-speed travel zones that require complex maneuvering.

### Actuator Control Process Prior Information

Actuator control processes of various types may take advantage of prior information 128 typically in the form of a model that is provided at initiation of the process and that may influence the performance characteristics and output of the actuator control process. This may result in the output from a given actuator control process being better suited (and therefore producing better performance, by some metric) to the properties of a particular function-related feature when the actuator control process makes use of prior information, compared to when the actuator control process does not make use of prior information. Therefore, it may be desirable to associate prior information contained in a model with corresponding different function-related features.

For example, given information about the ego vehicle's current position and knowledge of the properties of the road network available in the database, it is generally possible to generate a nominal speed associated with travel along a particular road segment. Based on this it may be possible to infer whether or not vehicle motion (including both longitudinal motion and yaw (e.g., steering-induced motion) arising from given actuator inputs can be accurately predicted through the use of models of varying complexity. Examples of models of varying complexity include kinematic models and dynamic models of increasing order that consider effects such as longitudinal wheel slip, vehicle rollover, and lateral skidding.

Control processes that exploit prior information contained in a model can generally be referred to as “model-based control processes.” Model based control processes generally work better when the specific model used in the control process accurately represents the physical relationship described by the model. Therefore it may be desirable to associate with a particular type of function-related feature a prior model that is expected to accurately represent the physical relationship described by the model during operation of the vehicle in the particular function-related feature.

### Different Decision Making Processes

As also shown in FIGS. 4A and 4B, self-driving vehicles use software processes termed decision making processes 130 to compute one or a sequence of navigation decisions 132. Such navigation decisions can generally be associated with desired high-level or longer-range objectives (defined by a user or an automated process or a combination of the two), such as goal positions, trajectories, or waypoints, all of which may have associated temporal components (for example, the objective to get to Joe's tavern by 6 PM). Examples of navigation decisions include the decision to change travel lanes on a highway, the choice of travel speed on a secondary road, the determination of the instant at which motion should be initiated at a crowded four-way stop intersection, the determination of the instant at which a complex merging maneuver at a roundabout should be initiated, and others. Such navigation decisions can be generated by a variety of known techniques, including finite state machines, decision trees, fuzzy logic, formal logic, and other techniques. The result of the computations done at each time step k in a decision making process may include a set of desired goal positions, trajectories, or waypoints, all of which may have associated temporal components.

Certain decision making processes may exhibit performance characteristics that vary depending on the operational environment (e.g., function-related features). Therefore, it may be desirable to associate different decision making processes with different types of function-related features, so that when the ego vehicle transitions between function-related features it makes a corresponding transition between execution of different decision making processes.

For example, a certain decision making process (process A) 133 based on finite state machines may rapidly calculate a desirable navigation decision in scenarios where the decision-space of possible decisions is small and may therefore be well-suited to scenarios involving driving on highways, where the decision space relates primarily to determination of the vehicle's appropriate travel speed and lane. Another decision making process (process B) based on formal logic may calculate a desirable navigation decision in scenarios where the space of possible decisions is large and may therefore be well-suited to scenarios involving driving in crowded urban centers. For driving in crowded urban centers, the decision making process must adhere to a rule set governing not only vehicles but pedestrians and cyclists, and the vehicle must negotiate intersections. The corresponding decision space relates not only to the vehicle's appropriate travel speed and lane but also to the temporal sequencing of actions in light of complex actions of other road users.

Therefore, based on known properties of decision making process A and decision making process B, it may be desirable to use process A for types of function-related features that are associated with highways, freeways, turnpikes, and other high-speed travel zones, and process B for types of function-related features associated with parking lots, driveways, pedestrian zones that allow vehicular traffic, and other low-speed travel zones that require complex maneuvering.

### Decision Making Process Parameter Settings

Decision making processes of various types generally rely on user-selected parameter settings 140 that influence the performance characteristics and output of the decision making process. This may result in output from a given decision making process that uses given parameter settings being better suited (and therefore producing better performance, by some metric) to the properties of a particular type of function-related feature. Therefore, it may be desirable to associate different sets of parameters for a given decision making process with different function-related features.

For example, a certain decision making process based on finite state machines, using a parameter set A that restricts the breadth of allowable decisions, may be well-suited to scenarios involving driving at high speeds on highways where the space of possible decisions is small and relates primarily to determination of the vehicle's appropriate travel speed and lane. The same decision making process using a parameter set B that expands the breadth of allowable decisions may be well-suited to driving in crowded urban centers. In urban centers, the space of possible decisions is large, and the decision making process must adhere to a rule set governing not only vehicles but pedestrians and cyclists. The vehicle also must negotiate intersections corresponding to a decision space that relates not only to the vehicle's appropriate travel speed and lane but also the temporal sequencing of actions in light of complex actions of other road users.

Therefore, based on known properties (characteristics 139) of the decision making process using parameter set A and using parameter set B, it may be desirable to use the process employing parameter set A for types of function-related features that are associated with highways, freeways, turnpikes, and other high-speed travel zones, and the process employing parameter set B for types of function-related features associated with parking lots, driveways, pedestrian zones that allow vehicular traffic, and other low-speed travel zones that require complex maneuvering. Parameter sets may also adjust the level of assertiveness of the vehicle, define the rules of the road or cultural norms in different areas, including but not limited to time to wait at an intersection and whether overtaking on the right is permissible by local law.

### Adjustment of Perception Process Parameter Settings

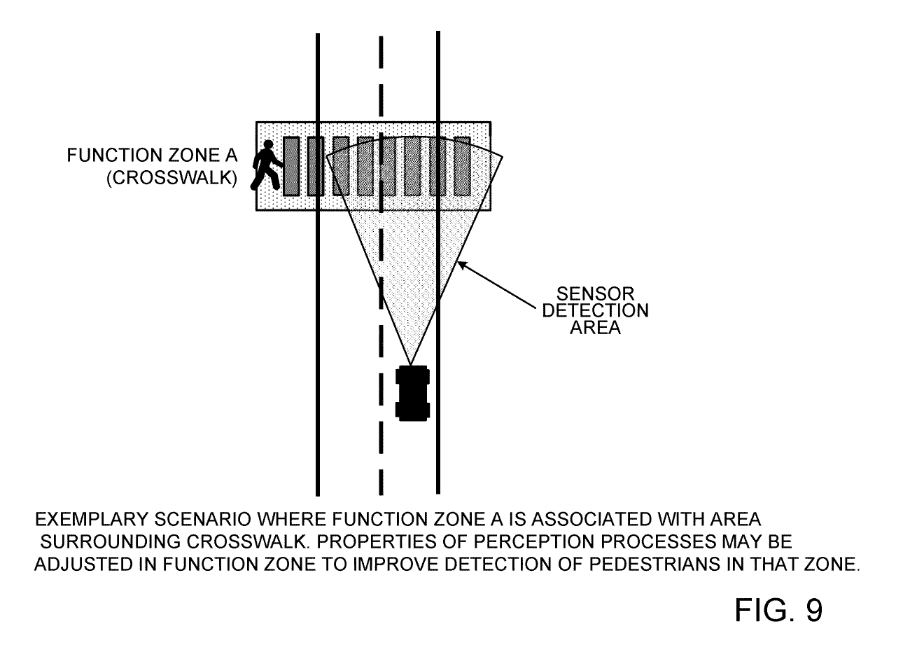

As also shown in FIGS. 4A and 4B and as also illustrated in FIG. 9, self-driving vehicles use software processes termed perception processes 141 to analyze data 142 collected from one or more sensors 144 (e.g., LIDAR, RADAR, ultrasonic, video, inertial measurement sensors, wheel odometry sensors, etc.) to compute various data products 146 with an aim of generating a “world model” 148 that describes information (e.g., current and estimated future position and velocity, type/class of object, etc.) that is relevant to vehicle driving. Examples of typical data products include identified vehicles, pedestrians, cyclists, static objects, lane markers, railroad crossings, signs (including both sign position and content), traffic lights (including traffic light type and state), and others, and combinations of them. These data products may be computed by analysis of data collected by a single sensor or by analysis of data collected by multiple sensors in a sensor fusion (or data fusion) process. The result of the computations done at each time step k in a perception process may include a world model at the current time, and an estimated evolution of the world model from the current time to a future time k+T.

Perception processes of various types generally rely on user-selected parameter settings 150 that influence the performance characteristics and output 146 of the perception process. As a result, output from a given perception process that uses given parameter settings may be better suited (and therefore produce better performance, by some metric) to the properties of a particular function-related feature. Therefore, it may be desirable to associate different sets of parameters for a given perception process with different function-related features.

For example, a certain object detection perception process using a parameter set A may discount the importance of RADAR (or another sensor type) in a sensor fusion perception process in a geographic area where certain road infrastructure affects the quality of sensor readings, such as via the induction of invalid measurements.

In some cases, a certain sensor fusion perception process employing a parameter set A that heavily weights long-range RADAR data for the purpose of detecting vehicles at long range, at the expense of precise estimation of vehicle position, may be well-suited to scenarios involving driving on highways where long-range detection of vehicles is required in order to give sufficient reaction time to respond to emergency situations. In some cases, the same sensor fusion perception process employing a parameter set B that heavily weights short-range LIDAR data for the purpose of precisely detecting vehicle position at short range, at the expense of accurate vehicle detection at longer range, may be well-suited to driving in crowded urban centers, where precise, short-range detection of vehicles is required.

In some instances, a perception process using a tunable RADAR sensor employing a parameter set A that adjusts the RADAR sensor to collect data at long range with a narrow field of view for the purpose of detecting vehicles at long range, at the expense of detecting vehicles in the broader surroundings, may be well-suited to scenarios involving driving on highways where long-range detection of vehicles is required in order to give sufficient reaction time to respond to emergency situations. In contrast, the same perception process using a tunable RADAR sensor employing a parameter set B that adjusts the RADAR sensor to collect data at short range with a wide field of view for the purpose of detecting vehicles at short range, though in a broader surrounding region, may be well-suited to driving in crowded urban centers, where precise, short-range detection of vehicles is required.

Therefore, in various examples, based on known properties of the perception process when it is using parameter set A and when it is using parameter set B, it may be desirable to use the process with parameter set A for function-related features that are associated with highways, freeways, turnpikes, and other high-speed travel zones, and to use the process with parameter set B for function-related features associated with parking lots, driveways, pedestrian zones that allow vehicular traffic, and other low-speed travel zones that require complex maneuvering.

In some implementations, the output of a certain perception process that enables detection of vehicles and pedestrians may be ignored completely when the detected vehicles and pedestrians lie outside a function-related feature that describes the drivable road surface and a nearby buffer zone, because such vehicles and pedestrians (e.g., vehicles parked in a distant parking lot, or pedestrians walking on a sidewalk that is far from the road) are considered to be irrelevant to the driving task.

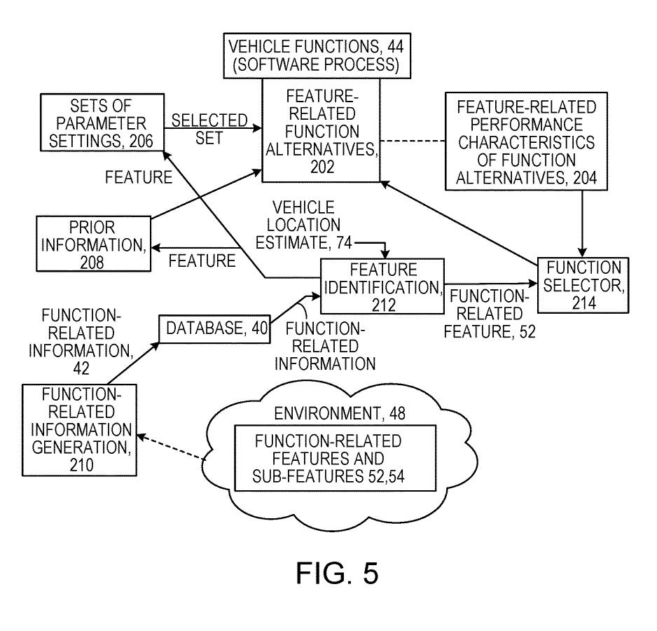

Therefore, as shown in FIG. 5, in general, vehicle functions 42 can include software processes and any other driving or operating or other functions of a vehicle. Each of the vehicle functions 42 can have feature-related function alternatives 202. These could be represented, for example, by different software processes, different instances of a single process, or different modes of operation of a process, or combinations of them. The feature-related function alternatives have characteristics 204 related to their performance. Different characteristics of a given function alternatives may suggest that it is especially useful with respect to certain function-related features or types of function-related features. Based on a location estimate 74 for a vehicle at a given time, and based on function-related information available in database 30, a function identification process 212 can continually be identifying function-related features 52 in the environment 48 that are relevant to the vehicle's operation. Several different processes can make use of the information about the function-related features provided by the feature identification process.

For example, a function selector 212 can use information about feature-related performance characteristics 204 of function alternatives together with the identified feature information to select among the feature-related function alternatives or to alter or affect in a wide variety of other ways the operation of a vehicle function.

Also, for example, a prior information process 208 can use the information about the identified features in generating, updating, or modifying prior information and then providing it to the currently active vehicle function.

Also, for example, a process that manages sets of parameter settings 206 and provides selected sets to the feature-related function alternatives can operate in response to the identified function-related features.

The function-related information 42 in the database 30 can be generated by a function-related information generation process to 10, which can be manual, semi-automated, automated, or a combination of them, based on known, observed, or identified function-related features and sub features 52, 54 in the environment 48.

### Different Localization Processes

As also shown in FIGS. 4A and 4B, self-driving vehicles use software processes termed localization processes 162 to analyze data 166 collected from one or more sensors 164 (e.g., LIDAR, RADAR, ultrasonic, video, inertial measurement sensors, GPS, wheel odometry sensors, etc.) or the perception processes 141 to compare various data inputs 166 against a database of previously recorded data (commonly processed into a “map” stored on-board the vehicle) 168 with an aim of generating a precise pose estimate 170 of the vehicle at the current time.

Example data inputs include lane marker information, road curbs, raw or processed sensor readings from RADAR and LIDAR, the most recent GPS pose, and relative vehicle motion estimates from odometry and inertial measurement sensors. These data inputs are commonly combined in the localization process into a probabilistic state estimate based on a filtering process (for example, a Kalman or particle filter process) to compute the pose of the vehicle with respect to the map at the current time.

Different localization processes may utilize different data inputs. For example, GPS precision may be poor in urban regions due to well-known multipath and other errors, lack of satellite availability, for example. Similarly, lane marker information may be unavailable in certain regions.

Therefore, based on known properties of localization process A and localization process B, it may be desirable to use process A for types of function-related features that are associated with highways, and process B for types of function-related features associated with urban settings.

### Sensor Data Recording On-Board the Vehicle

Different geographic regions may impose restrictions on what data may be collected by a self-driving vehicle. For example, privacy laws may differ among states or countries and disallow the collection of video data on-board the vehicle.

Therefore, it may be desirable to disallow or restrict the duration of sensor data recording or storage on- and off the vehicle for types of function-related features that are associated with different areas including, but not limited to, countries, states, and communities, based on prior knowledge of the respective local laws or policies.

### Transitions Between Function-Related Features

A given geographic region may have associated with it two or more function-related features. In this scenario, if each function-related feature would cause a modification of (affect) the structure or performance of software processes on the vehicle in a contradictory or conflicting manner, an arbitration method can be employed to prioritize one function-related feature above others for purposes of influencing a process, or run multiple processes concurrently and choose, switch between, or otherwise merge the outputs of the multiple processes.

In practice, when the ego-vehicle engages in transitions between geographic regions associated with different function-related features, care must be taken to ensure that the transition between different software processes (or different operating modes of a given software process) associated with the respective different function-related features does not result in abrupt changes in vehicle behavior. Such abrupt changes may cause vehicle motion that is uncomfortable or unsafe to a passenger or unusual to an outside observer. A variety of methods may be pursued to ensure that transitions between different software processes (or different modes of operation of a given software process) are accomplished in such a manner that vehicle operation remains safe, stable, and robust, including one or more of the following exemplary methods:

1. Comparing the outputs of the software processes (or modes of operation of a software process) associated with the respective function-related features and ensuring smooth transitioning between software process outputs through the use of a filtering method (e.g., averaging filter, low-pass filter, exponential moving average filter) on the value of the outputs;
2. Allowing a transition between outputs of the software processes associated with the respective function-related features and ensuring smooth transitioning between software process outputs by only allowing the transition when the difference between the outputs is smaller than a pre-defined threshold;
3. Ensuring a smooth transitioning between software process outputs by smoothly transitioning between the software process parameter settings associated with the respective function-related features;
4. Allowing the transition between outputs of the software processes associated with the respective function-related features, but ensuring that the outputs do not switch back and forth at high frequency (potentially due to the presence of high frequency noise in the vehicle's location estimate) by applying a hysteresis function.

Information about function-related features can be used during operation of either or both of a physical vehicle or of a simulation process, in which a model (at a chosen level of fidelity) of the vehicle and environment are analyzed to study or predict vehicle operational performance characteristics in a range of user-defined scenarios. Such a simulation process could be executed on the vehicle during operation (to yield a model-based predictive capability of future operational performance) or on computing resources located in an office or in the cloud.

In certain scenarios a vehicle may be controlled or managed in certain or all functions by a remote operator (termed a “teleoperator”). We use the term teleoperator broadly to include any person or software process that is located away from the vehicle and receives over a wireless communication link sufficient information (e.g., video feedback captured by a forward-facing video camera) to provide actuator input levels, navigation decisions, or other vehicle operation commands. In scenarios where the vehicle is under teleoperator control, the vehicle may be considered in effect to lie within a function-related feature that may result in the affecting of one or more of the processes described above.

### Generation of Function-Related Information

As discussed earlier, function-related information 42 may be included in a road network information database or similar database and can contain information, such as geographically-dependent information, that can be used to modify (affect) the operation or performance of a vehicle such as an autonomous vehicle such as to affect the operation of software processes associated with such operational performance. The function-related information can be generated in several ways, including through the use of manual, semi-automated, or automated processes, as described below. Function-related information generated by any of these processes (or any combination of them) can be stored in a database in memory units located on automated vehicles or located on a cloud server and accessed by wireless communication by numerous automated vehicles that have access to that communication network.

Manual Generation of Function-Related Information

Function-related information can be generated by a software process termed a manual map labeling process. Such a process requires a human user to identify or define different function-related features and associate geometric regions and the road network information related to these regions with different function-related features, using a variety of possible input devices and user interfaces.

A manual map labeling process might present to a user a visual representation of a road network on a display screen, including an aerial view of the road network overlaid with a graphical representation of the connectivity of the travel lanes present in the road network. The user could then “paint,” or bound with geometric shapes of varying size, function-related features associated with highways, parking lots, driveways, toll booths, or other road features are geographic regions.

A manual map labeling process can be run on a computer processor that is not located on a vehicle or it may be run on a computer processor that is located on a vehicle or both. In applications in which the manual map labeling process is run on a computer processor that is located on an autonomous vehicle, a vehicle passenger or other human user could manually identify the presence of and the boundaries of one or more different physical roadway structures or geographic regions through a user interface. A function-related feature associated with the distinct physical roadway structure or geographic region could then be generated by the manual map labeling process.

As an example of such a process, when an automated vehicle enters a parking lot, a vehicle passenger could employ an in-vehicle user interface to indicate that the vehicle has entered a parking lot. Alternatively, a vehicle-to-infrastructure communication process could send a message to the vehicle to indicate that the vehicle has entered a parking lot. Function-related information for a function-related feature of the type associated with parking lots then can be generated by the manual map labeling process, and various software processes could then be automatically adjusted to optimize vehicle performance for operation in parking lots.

Semi-Automated Generation of Function-Related Information

Function-related features can be defined using a software process termed a semi-automated map labeling process. This process can use one or more supervised or unsupervised classification algorithms to automatically identify distinct physical roadway structures based on analysis of characteristic visual, geometric, or other features associated with the structures, including features derived from observed traffic flow and from data collected by manually-driven vehicles or automated vehicles. Such classification algorithms include, for example, support vector machines, neural networks (including convolutional neural networks and similar “deep learning” methods), and others.

A human user then can be presented with the classified physical roadway structures and asked to accept, label, modify, or reject the classifications. If the human user accepts or modifies a classification, a function-related feature associated with the particular physical roadway structure is assigned to the geographic region or regions associated with the roadway structures. Such a method promises to increase efficiency in function-related feature definition, because part of the labeling process is performed rapidly and automatically by a machine.

A semi-automated map labeling process can be run on a computer processor that is not located on a vehicle, or it may be run on a computer processor that is located on a vehicle. In applications where the semi-automated map labeling process is run on a computer processor that is located on a vehicle, data collected by sensors located on board the vehicle are analyzed, potentially in concert with data stored on a memory located on the vehicle or in the cloud, to identify the presence of distinct physical roadway structures associated with distinct function-related features. A vehicle passenger or other human user is then presented with the classified physical roadway structures and asked to accept, label, modify, or reject the classifications.

As an example of such a process, data collected by a vision sensor mounted on the vehicle could be analyzed to detect geometric and color features associated with traffic cones, thereby indicating the likely presence of a construction zone. When such a construction zone is identified, a vehicle passenger or remote vehicle monitor could be asked to confirm that the nearby road contains a construction zone using a visual prompt on an in-vehicle display, an auditory prompt, or some other prompt. If the passenger or remote monitor answers affirmatively, function-related information for a function-related feature of the type associated with construction zones can be associated with the geographic region or regions associated with the detected cones by the semi-automated map labeling process, and various software processes could then be automatically adjusted to optimize vehicle performance for operation in construction zones.

Automated Generation of Function-Related Features

Function-related features can be defined using a software process termed an automated map labeling process. This process can use one or more supervised or unsupervised classification algorithms to automatically identify distinct physical roadway structures or geographic regions based on analysis of unique visual, geometric, or other features associated with the structures, including features derived from observed traffic flow and from data collected by manually-driven vehicles or automated vehicles. Such classification algorithms include, for example, support vector machines, neural networks (including convolutional neural networks and similar “deep learning” methods), and others. Function-related information for a function-related feature associated with the distinct physical roadway structure is then automatically assigned to the geographic region(s) associated with the roadway structures. Such a method promises to greatly increase efficiency in function-related feature definition, since all of the labeling process is performed rapidly by a machine, however care must be taken to ensure that the algorithms employed for automated identification are highly accurate, since erroneous classifications by the classification process could lead to erroneous function-related feature assignment.

An automated map labeling process can be run on a computer processor that is not located on a vehicle, or it may also be run on a computer processor that is located on a vehicle. In applications where the automated map labeling process is run on a computer processor that is located on a vehicle, data collected by sensors located on board the vehicle are analyzed, potentially in concert with data stored on a memory located on the vehicle or in the cloud, to identify the presence of distinct physical roadway structures associated with distinct function-related features. Function-related features are then automatically defined based on the geometric region(s) associated with these roadway structures.

As an example of such a process, data collected by a vision sensor mounted on the automated vehicle could be analyzed to detect color and texture features associated with unpaved roads. When an unpaved road is identified, a function-related feature associated with the unpaved road can be associated with the geographic region(s) associated with the unpaved road by the semi-automated map labeling process, and various software processes could then be automatically adjusted to optimize vehicle performance for operation on unpaved roads.

Other implementations are also within the scope of the following claims.

1. A method comprising
based on information received about a function-related feature of an environment of a vehicle that has been identified in connection with a location of the vehicle, affecting execution of a function of a vehicle to alter performance characteristics of the function based on the identified function-related feature.

2. The method of claim 1 in which the function-related feature comprises a geographic region.

3. The method of claim 1 in which the function-related feature comprises a road feature.

4. The method of claim 1 in which the function comprises a software process.

5. The method of claim 1 in which the function comprises motion planning.

6. The method of claim 1 in which the function comprises trajectory tracking.

7. The method of claim 1 in which the function comprises actuator control.

8. The method of claim 1 in which the function comprises decision-making.

9. The method of claim 1 in which the function comprises perception processing.

10. The method of claim 1 in which the function comprises localization of the vehicle.

11. The method of claim 1 in which the function comprises sensor data recording on-board the vehicle.

12. The method of claim 1 in which the execution of the function is affected by switching from one function to another function.

13. The method of claim 1 in which the execution of the function is affected by altering an operation of a function.

14. The method of claim 1 in which the affecting of the execution of the function is based on parameter settings.

15. The method of claim 14 in which the parameter settings are selected from among two or more different sets of parameter settings.

16. The method of claim 1 in which the affecting of the execution of the function is based on prior information.

17. The method of claim 16 in which the prior information comprises a simulation model.

18. The method of claim 16 in which the prior information includes two or more simulation models.

19. The method of claim 1 comprising receiving the information about the function-related feature from a database.
